(19) United States
(12) Patent Application Publication
(10) Pub. No.: US 2020/0007357 A1
(43) Pub. Date: Jan. 2, 2020

(54) APPARATUS AND METHOD FOR SMART HOME MONITORING

(71) Applicant: LG ELECTRONICS INC., Seoul (KR)

(72) Inventor: Hyeong Jin Kim, Incheon (KR)

(73) Assignee: LG ELECTRONICS INC., Seoul (KR)

(21) Appl. No.: 16/557,026

(22) Filed: Aug. 30, 2019

(30) Foreign Application Priority Data
Aug. 2, 2019 (KR) 10-2019-0094430

(51) Int. Cl. H04L 12/28; G01S 15/89; G08B 19/00; G08B 13/16; G08B 13/196

(52) U.S. Cl. CPC H04L 12/2827; G01S 15/8993; G08B 13/19613; G08B 13/1681; G08B 19/00

(57) ABSTRACT

A smart home monitoring apparatus which drives the smart home monitoring apparatus by executing an artificial intelligence (AI) algorithm and/or a machine learning algorithm in a 5G environment connected for Internet of Things. The smart home monitoring apparatus and method according to the exemplary embodiment of the present disclosure includes generating a spatial map of a monitoring area, transmitting a first inaudible sound wave signal to the monitoring area to receive a first inaudible sound wave echo signal, predicting a possibility of abnormal state occurrence of the monitoring area through the first inaudible sound wave echo signal based on the spatial map of the monitoring area, obtaining an image of the monitoring area photographed by the camera when the abnormal state occurrence of the monitoring area is predicted, and determining whether an abnormal state occurs in the monitoring area by analyzing the obtained image.

### CROSS-REFERENCE TO RELATED APPLICATION

This present application claims benefit of priority to Korean Patent Application No. 10-2019-0094430, entitled “APPARATUS AND METHOD FOR SMART HOME MONITORING” filed on Aug. 2, 2019, in the Korean Intellectual Property Office, the entire disclosure of which is incorporated herein by reference.

### BACKGROUND

### 1. Technical Field

The present disclosure relates to a smart home monitoring apparatus and method, and more particularly, to a smart home monitoring apparatus and method which monitor an abnormal state of a predetermined monitoring area by utilizing a multimodal fusion sensor (an ultrasonic sensor and a vision camera sensor).

### 2. Description of the Related Art

In order to detect fire occurring at home, temperature detection, smoke detection, and vision-based detection are used. That is, when a temperature abnormally rises, smoke is detected, or a lire image is captured, it is detected that the fire occurs.

Specifically, the related art 1 discloses a fire monitoring method based on detection of a change in a sound field which can detect a variation in a sound field in a fire monitoring space in accordance with a temperature change of the surrounding air due to the tire to detect the lire early even in a state that a flame or a smoke is not visibly recognized.

Further, the related art 2 discloses a crime preventing method using sound signal analysis having a spatial resolution function in accordance with a configuration position of a generating device and an analysis device of a sound signal which detects whether a sound signal is abnormal in a specific frequency band to determine whether an external environment is abnormal.

That is, according to the relates arts 1 and 2, the fire which is generated at home is monitored using a sound wave to detect the fire even in a state in which a flame or a smoke is not visibly recognized. However, according to the related arts 1 and 2, the fire which has already occurred is detected and the similar monitoring result is obtained by motions such as trespassing, other than the fire so that a monitoring accuracy is lowered.

The above-described background arts are technical information held or acquired by the inventor for deriving the present disclosure so that it cannot be referred to as known arts disclosed to the general public prior to the filing of the contents to be disclosed.

### RELATED ART DOCUMENT

### Patent Document

Patent Document 1: Korean Registered Patent Publication No. 10-1725119 (registered on Apr. 4, 2017).

Patent Document 2: Korean Registered Patent Publication No. 10-0707506 (registered on Apr. 6, 2007).

### SUMMARY OF THE INVENTION

An object of an exemplary embodiment of the present disclosure is to improve a performance of a smart home monitoring apparatus by monitoring an abnormal state of a predetermined monitoring area by utilizing a multimodal fusion sensor (an ultrasonic sensor and a vision camera sensor).

Another object of an exemplary embodiment of the present disclosure is to improve a performance and an economic efficiency of a smart home monitoring apparatus by expanding a coverage using one multimodal fusion sensor in a predetermined monitoring area to monitor the monitoring area.

Another object of an exemplary embodiment of the present disclosure is to solve a privacy problem caused when a camera always operates, by operating a vision camera after predicting an abnormal state of a predetermined monitoring area using a sound speed of an ultrasonic wave.

Another object of an exemplary embodiment of the present disclosure is to improve a reliability of a smart home monitoring apparatus by monitoring a temperature change based on a sound speed of an ultrasonic wave and cross-checking with a vision camera when an abnormal temperature is detected to enable more accurate monitoring.

Another object of an exemplary embodiment of the present disclosure is to improve usage convenience and usage satisfaction by applying the apparatus to a smart home appliance such as an AI speaker or a TV at home and periodically scanning a predetermined monitoring area using the applied home appliance to remotely share a monitoring result of the predetermined monitoring area in real-time without having a separate device.

Another object of an exemplary embodiment of the present disclosure is to improve a performance of a smart home monitoring apparatus by accurately and quickly detecting whether an abnormal state occurs in a predetermined area using artificial intelligence and/or a machine learning algorithm.

Another object of an exemplary embodiment of the present disclosure is to improve an accuracy of a smart home monitoring apparatus by generating a spatial map for a fixed object in advance and reflecting data for a moving object to the spatial map by motion detection.

Another object of an exemplary embodiment of the present disclosure is to improve a user's satisfaction by detecting stranger's trespassing as well as the fire to provide an alarm using at least one of a smart home monitoring apparatus, a user terminal, and a smart home appliance.

The object of the exemplary embodiment of the present disclosure is not limited to the above-mentioned objects and other objects and advantages of the present disclosure which have not been mentioned above may be understood by the following description and become more apparent from exemplary embodiments of the present disclosure. Further, it is understood that the objects and advantages of the present disclosure may be embodied by the means and a combination thereof in the claims.

The smart home monitoring method according to an aspect of the present disclosure may include monitoring an abnormal state of a predetermined monitoring area by utilizing a multimodal fusion sensor (an ultrasonic sensor and a vision camera sensor).

Specifically, according to an exemplary embodiment of the present disclosure, a smart home monitoring method includes: generating a spatial map of a monitoring area, transmitting a first inaudible sound wave signal to the monitoring area to receive a first inaudible sound wave echo signal, predicting a possibility of abnormal state occurrence of the monitoring area through the first inaudible sound wave echo signal based on the spatial map of the monitoring area, obtaining an image of the monitoring area photographed by the camera when the abnormal state occurrence of the monitoring area is predicted, and determining whether the abnormal state occurs in the monitoring area by analyzing the obtained image.

According to the exemplary embodiment of the present disclosure, by the smart home monitoring method, it is possible to improve a performance and a reliability of a smart home monitoring apparatus by monitoring an abnormal state of a predetermined monitoring area by utilizing a multimodal fusion sensor (an ultrasonic sensor and a vision camera sensor).

Further, the generating of a spatial map of a monitoring area may include obtaining initial information of the first inaudible sound wave echo signal from the monitoring area by scanning the monitoring area through the first inaudible sound wave signal; and obtaining distance information of a fixed object by recognizing a distance from the fixed object in the monitoring area through the camera.

According to an exemplary aspect of the generating of a spatial map of a monitoring area, the spatial map for the fixed object is generated in advance and data for a moving object is reflected in the spatial map by detecting a motion to detect the monitoring area, thereby improving an accuracy of a smart home monitoring apparatus.

Further, the predicting of a possibility of abnormal state occurrence may include: obtaining a speed of the first inaudible sound wave in accordance with the first inaudible sound wave echo signal; identifying a temperature for an arbitrary part in the monitoring area by a correlation between a speed of the first inaudible sound wave and a temperature; and determining whether the abnormal state occurs based on a temperature change in the arbitrary part in the monitoring area.

Further, the predicting of a possibility of abnormal state occurrence may include: predicting a possibility of fire occurrence when the temperature of the arbitrary part in the monitoring area reaches a predetermined setting temperature or the temperature change of the arbitrary part in the monitoring area is equal to or higher than a predetermined reference value.

Further, according to an exemplary aspect of the predicting of a possibility of abnormal state occurrence, the possibility of fire occurrence is predicted based on a temperature change in a predetermined monitoring area, according to a correlation between a sound speed of an ultrasonic wave and a temperature, to prevent or cope with the fire before the fire occurrence, thereby improving a user's satisfaction and a reliability of a smart home monitoring apparatus.

Further, the determining of whether an abnormal state occurs may include: determining whether fire occurs by comparing an image photographed by the camera and a previously stored fire image.

According to an exemplary aspect of the determining of whether an abnormal state occurs, it is possible to improve a reliability of a smart home monitoring apparatus by monitoring a temperature change based on a sound speed of an ultrasonic wave and cross-checking with a vision camera when an abnormal temperature is detected to enable more accurate monitoring.

Further, a smart home monitoring method according to an exemplary embodiment of the present disclosure may further include: transmitting a second inaudible sound wave signal to the monitoring area to receive a second inaudible sound wave echo signal, and detecting whether there is a motion of an object in the monitoring area using the second inaudible sound wave echo signal based on the spatial map of the monitoring area.

According to the exemplary embodiment of the present disclosure, by the smart home monitoring method, it is possible to improve a user's satisfaction by monitoring stranger's trespassing as well as the fire to provide an alarm using at least one of a smart home monitoring apparatus, a user terminal, and a smart home appliance.

Further, the obtaining of an image of the monitoring area may include: photographing the monitoring area using the camera when a degree of motion of the object detected by the second inaudible sound wave echo signal is equal to or lower than a predetermined reference value.

According to an exemplary aspect of the obtaining of the photographed image of the monitoring area, it is possible to solve a privacy problem caused when a camera always operates by operating a vision cameral after predicting an abnormal state of a predetermined monitoring area using a sound speed of an ultrasonic wave.

Further, a smart home monitoring method according to an exemplary embodiment of the present disclosure may further include: analyzing a moving object when a degree of motion of the object detected by the second inaudible sound wave echo signal exceeds a predetermined reference value, and the predicting of a possibility of abnormal state occurrence may include: predicting a possibility of abnormal state occurrence by reflecting moving object information in accordance with the moving object analysis result.

Further, the smart home monitoring method according to an exemplary embodiment of the present disclosure may further include: outputting an alarm for stranger's trespassing when the moving object is determined as a human as the moving object analysis result if a user is located at the outside of the monitoring area.

Further, the smart home monitoring method according to an exemplary embodiment of the present disclosure may further include: outputting an alarm including one or more contents of a fire image, a cause of fire, and a fire extinguishing plan when the tire occurrence is determined.

The smart home monitoring method according to the exemplary embodiment of the present disclosure may provide usage convenience and usage satisfaction by applying the method to a smart home appliance such as an AI speaker or a TV at home and periodically scanning a predetermined monitoring area using the applied home appliance to remotely share a monitoring result of the predetermined monitoring area in a real time without having a separate device.

According to an exemplary embodiment of the present disclosure, a smart home monitoring apparatus may include: a map generating unit which generates a spatial map of a monitoring area; a first receiving unit which transmits a first inaudible sound wave signal to the monitoring area to receive a first inaudible sound wave echo signal; a predicting unit predicting a possibility of abnormal state occurrence of the monitoring area through the first inaudible sound wave echo signal based on the spatial map of the monitoring area; an image obtaining unit which obtains an image of the monitoring area photographed by the camera when the abnormal state occurrence of the monitoring area is predicted, and a controller which determines whether the abnormal state occurs in the monitoring area by analyzing the obtained image.

According to the exemplary embodiment of the present disclosure, by the smart home monitoring apparatus, it is possible to improve a performance and an economic efficiency of the smart home monitoring apparatus by expanding a coverage using one multimodal fusion sensor in a predetermined monitoring area to monitor the monitoring area.

Further, the map generating unit may scan the monitoring area by the first inaudible sound wave signal to obtain initial information of a first inaudible sound wave echo signal from the monitoring area and recognize a distance of a fixed object in the monitoring area through the camera to obtain the distance information of the fixed object.

By providing the map generating unit according to the exemplary embodiment of the present disclosure, it is possible to generate the spatial map for the fixed object in advance and perform the smart home monitoring based on the spatial map to improve the accuracy of the smart home monitoring apparatus.

Further, the predicting unit may obtain a speed of the first inaudible sound wave in accordance with the first inaudible sound wave echo signal, identify a temperature for an arbitrary part in the monitoring area by a correlation between the speed of the first inaudible sound wave and a temperature, and determine whether an abnormal state occurs based on the temperature change for the arbitrary part in the monitoring area.

Further, the predicting unit may predict a possibility of fire occurrence when the temperature of the arbitrary part in the monitoring area reaches a predetermined setting temperature or the temperature change of the arbitrary part in the monitoring area is equal to or higher than a predetermined reference value.

By providing the predicting unit according to the exemplary embodiment of the present disclosure, a performance of a smart home monitoring apparatus may be improved by monitoring an abnormal state of a predetermined monitoring area by utilizing a multimodal fusion sensor (an ultrasonic sensor and a vision camera sensor). Further, the predicting unit monitors the temperature change based on a sound speed of an ultrasonic wave and performs cross-checking with a vision camera when an abnormal temperature is detected to enable more accurate monitoring, thereby improving a reliability of a smart home monitoring apparatus.

Further, the controller may determine whether fire occurs by comparing an image photographed by the camera and a previously stored fire image.

By providing the controller according to the exemplary embodiment of the present disclosure, a performance of a smart home monitoring apparatus may be improved by accurately and quickly detecting whether an abnormal state occurs in a predetermined area using artificial intelligence and/or a machine learning algorithm.

Further, the smart home monitoring apparatus according to an exemplary embodiment of the present disclosure may further include: a second receiving unit which transmits a second inaudible sound wave signal to the monitoring area to receive a second inaudible sound wave echo signal: and a motion detecting unit which detects whether there is a motion of an object in the monitoring area using the second inaudible sound wave echo signal based on the spatial map of the monitoring area.

The smart home monitoring apparatus according to the exemplary embodiment of the present disclosure may improve a user's satisfaction by monitoring stranger's trespassing as well as the fire to provide an alarm using at least one of a smart home monitoring apparatus, a user terminal, and a smart home appliance.

The image obtaining unit may photograph the monitoring area using the camera when a degree of motion of the object detected by the second inaudible sound wave echo signal is equal to or lower than a predetermined reference value.

By providing the image obtaining unit according to the exemplary embodiment of the present disclosure, it is possible to solve a privacy problem caused when a camera always operates by operating a vision cameral after predicting an abnormal state of a predetermined monitoring area using a sound speed of an ultrasonic wave.

Further, the motion detecting unit may analyze a moving object when a degree of motion of the object detected by the second inaudible sound wave echo signal exceeds a predetermined reference value and the predicting unit may predict a possibility of abnormal state occurrence by reflecting moving object information in accordance with the moving object analysis result.

The controller may output an alarm for stranger's trespassing when the moving object is determined as a human as the moving object analysis result if a user is located at the outside of the monitoring area.

The controller may output an alarm including one or more contents of a fire image, a cause of tire, and a fire extinguishing plan when the fire occurrence is determined.

By providing the motion detecting unit and the controller according to the exemplary embodiment of the present disclosure, usage convenience and usage satisfaction may be improved by applying the units to a smart home appliance such as an AI speaker or a TV at home and periodically scanning a predetermined monitoring area using the applied home appliance to remotely share a monitoring result of the predetermined monitoring area in real-time without having a separate device.

In addition, another method and another system for implementing the present disclosure and a computer-readable recording medium in which a computer program for executing the method is stored may be further provided.

Other aspects, features, and advantages other than those described above will become apparent from the following drawings, claims, and the detailed description of the present invention.

According to the exemplary embodiment of the present disclosure, it is possible to improve a performance and a reliability of a smart home monitoring apparatus by monitoring an abnormal state of a predetermined monitoring area by utilizing a multimodal fusion sensor (an ultrasonic sensor and a vision camera sensor).

Further, a possibility of fire occurrence is predicted based on a temperature change in a predetermined monitoring area, according to a correlation between a sound speed of an ultrasonic wave and a temperature, to prevent or cope with the fire before the fire occurrence, thereby improving a user's satisfaction and a reliability of a smart home monitoring apparatus.

Further, a coverage is expanded using one multimodal fusion sensor in a predetermined monitoring area to monitor the monitoring area, thereby improving a performance and an economic efficiency of a smart home monitoring apparatus.

Further, a vision camera operates after predicting an abnormal state of a predetermined monitoring area through a sound speed of an ultrasonic wave to solve a privacy problem which may be caused when the camera always operates.

A temperature change is monitored based on a sound speed of an ultrasonic wave and cross-checking is performed with a vision camera when an abnormal temperature is detected to enable more accurate monitoring, thereby improving a reliability of a smart home monitoring apparatus.

As the apparatus can be applied to all the smart home appliances such as an AI speaker or a TV at home, a predetermined monitoring area is periodically scanned to remotely share a monitoring result of the predetermined monitoring area in real-time without having a separate device, thereby improving usage convenience and usage satisfaction.

Further, it is accurately and quickly detected whether an abnormal state occurs in a predetermined area using artificial intelligence and/or a machine learning algorithm, thereby improving a performance of a smart home monitoring apparatus.

A spatial map for a fixed object is generated in advance and data for a moving object is reflected in the spatial map by detecting a motion to detect a monitoring area, thereby improving an accuracy of a smart home monitoring apparatus.

Further, stranger's trespassing is detected as well as the fire to issue an alarm using at least one of a smart home monitoring apparatus, a user terminal, and a smart home appliance, thereby improving user's satisfaction.

Further, even though the smart home monitoring apparatus itself is a mass-produced uniform product, the user recognizes the smart home monitoring apparatus as a personalized apparatus, so that an effect as a user-customized product may be achieved.

The effects of the present disclosure are not limited to those mentioned above, and other effects not mentioned can be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary diagram of a smart home monitoring environment including a smart home monitoring apparatus according to an exemplary embodiment of the present disclosure, an electronic device, a user terminal, a server, and a network connecting the above-mentioned components:

FIG. 2 is a view for schematically explaining a smart home monitoring apparatus according to an exemplary embodiment of the present disclosure:

FIG. 3 is a view for explaining a correlation of a sound speed of a smart home monitoring apparatus according to an exemplary embodiment of the present disclosure and a temperature:

FIG. 4 is a schematic block diagram of a smart home monitoring apparatus according to an exemplary embodiment of the present disclosure:

FIG. 5 is a schematic block diagram of a processing unit of a smart home monitoring apparatus according to an exemplary embodiment of the present disclosure;

FIG. 6 is an exemplary diagram of schematically illustrating a spatial map of a smart home monitoring apparatus according to an exemplary embodiment of the present disclosure;

FIG. 7 is an exemplary diagram for explaining analysis of a fire image of a smart home monitoring apparatus according to an exemplary embodiment of the present disclosure;

FIG. 8 is an exemplary diagram of schematically illustrating an output unit of a smart home monitoring apparatus according to an exemplary embodiment of the present disclosure;

FIG. 9 is an exemplary diagram of schematically illustrating an output unit of a smart home monitoring apparatus according to an exemplary embodiment of the present disclosure when fire occurs;

FIG. 10 is a flowchart illustrating a smart home monitoring method according to an exemplary embodiment of the present disclosure; and

FIG. 11 is a flowchart illustrating a smart home monitoring method to which moving object analysis of a smart home monitoring apparatus according to an exemplary embodiment of the present disclosure is applied.

### DETAILED DESCRIPTION

Advantages and characteristics of the present invention and a method of achieving the advantages and characteristics will be clear by referring to exemplary embodiments described below in detail together with the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In describing the present invention, when it is determined that a detailed description of related well-known technology may obscure the gist of the present invention, the detailed description thereof will be omitted.

Terms used in the present application are used only to describe specific exemplary embodiments, and are not intended to limit the present invention. A singular form may include a plural form if there is no clearly opposite meaning in the context. In the present invention, it should be understood that terminology “include” or “have” indicates that a feature, a number, a step, an operation, a component, a part or the combination thoseof described in the specification is present, but do not exclude a possibility of presence or addition of one or more other features, numbers, steps, operations, components, parts or combinations, in advance. Terminologies such as first or second may be used to describe various components but the components are not limited by the above terminologies. The above terms are used only to discriminate one component from the other component.

Hereinafter, exemplary embodiments according to the present invention will be described in detail with reference to the accompanying drawings. In the description with reference to the accompanying drawings, like reference numbers and designations in the various drawings indicate like elements and a redundant description thereof will be omitted.

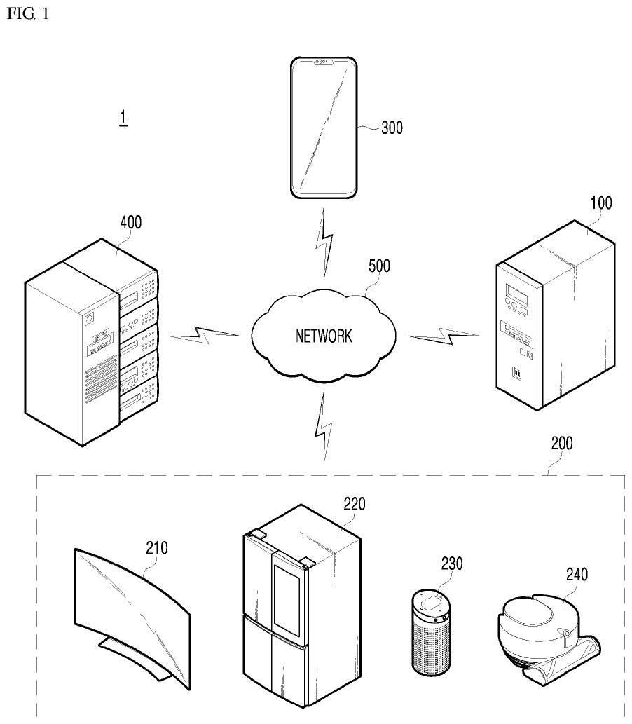

FIG. 1 is an exemplary diagram of a smart home monitoring environment including a smart home monitoring apparatus according to an exemplary embodiment of the present disclosure, an electronic device, a user terminal, a server, and a network connecting the above-mentioned components.

Referring to FIG. 1, a smart home monitoring environment 1 may include a smart home monitoring apparatus 100, an electronic device 200, a user terminal 300, a server 400, and a network 500.

The smart home monitoring apparatus 100 is an apparatus which monitors an abnormal state occurrence such as fire or stranger's trespassing in a predetermined space, for example, homes, offices, or hospitals. Here, the abnormal state may include various situations as well as the fire and the stranger's trespassing, but in the exemplary embodiment, the fire occurrence and the stranger's trespassing are described as examples. Specifically, in the present embodiment, the smart home monitoring apparatus 100 may use an inaudible sound wave sensor, such as an ultrasonic sensor, an infrasonic sensor, and a vision camera sensor, to monitor a space to be monitored. In this case, there is no need to provide a large number of sensors to monitor a predetermined space, but the sensors are provided as a fusion sensor in one space to monitor the predetermined space in all directions by changing the direction. That is, in the present embodiment, as the smart equipment and the Internet of Things (IoT) become full-fledged, a multimodal fusion sensor which overcomes uncertainty of single information collection and combines information collected from a plurality/multiple sensors is used to more accurately and quickly monitor the abnormal state occurrence. Here, the predetermined space is an arbitrary area to be monitored by the smart home monitoring apparatus 100 and hereinafter, referred to as a monitoring area.

In the meantime, a frequency of a sound wave that human ears can hear is generally in the range of 16 Hz to 20 kHz. In this case, sound waves transmitted above 20 kHz are ultrasonic waves and sound waves transmitted below 16 Hz are infrasonic waves. The ultrasonic wave refers to a wave which propagates while vibrating a medium in a certain direction and has a short wavelength and a good directivity to easily implement the soundwave detection. The infrasonic wave refers to a sound in a frequency range lower than the audible sound wave and has a long wavelength so that the wave may reach a long distance and a subtle motion of an object may be easily detected.

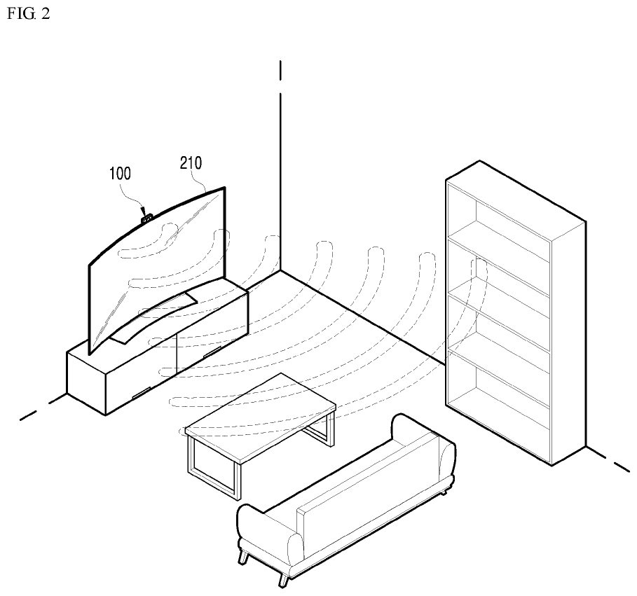

FIG. 2 is a view for schematically explaining a smart home monitoring apparatus according to an exemplary embodiment of the present disclosure. In the following description, a repeated description of FIG. 1 will be omitted. Referring to FIG. 2, in the present embodiment, the smart home monitoring apparatus 100 transmits an inaudible sound wave, for example, an ultrasonic wave and receives an echo signal to recognize a fixed object, such as a sofa, a table, or a bookshelf, in a space to be monitored. Further, the smart home monitoring apparatus 100 transmits an inaudible sound wave, for example, an infrasonic wave and receives an echo signal to detect a subtle motion of an object. Therefore, a subtle motion of an object generated when a user is sleeping at home may be detected.

In the meantime, in the present disclosure, the smart home monitoring apparatus 100 is applied to a TV 210 to monitor a space to be monitored. In this case, the smart home monitoring apparatus 100 which is applied to the TV 210 is desirably installed at an upper edge of the TV 210, but is not limited thereto. Further, the TV 210 is an example and the smart home monitoring apparatus 100 may be applied to any one of all electronic devices 200 equipped in the home. The electronic device 200 may include a terminal which can be implemented by voice recognition or artificial intelligence, a terminal, which outputs at least one of an audio signal and a video signal, and the like. For example, the electronic device 200 may include the TV 210, a refrigerator 220, an AI speaker 230, a robot cleaner 240, and the like. In the present embodiment, the electronic device 200 is limited to the above-described terminals, but the electronic device is not limited thereto and may include various home appliances (for example, a drying machine, a clothing care system, an air conditioner, and a Kimchi refrigerator).

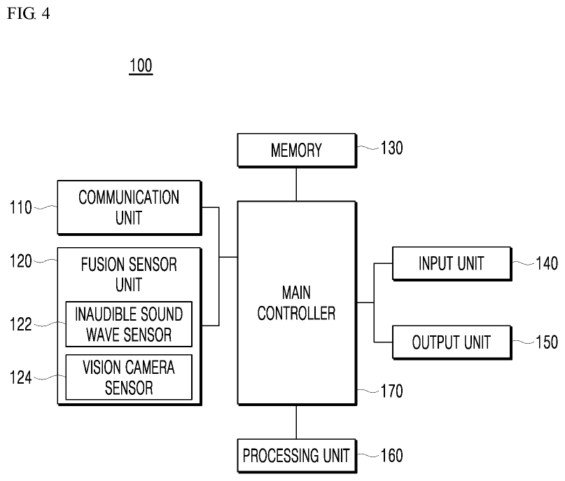

In the present embodiment, the smart home monitoring apparatus 100 may receive service request information from a user for the purpose of control. A method for receiving the service request information from the user by the smart home monitoring apparatus 100 may include a method of receiving a touch signal (or a button input) with respect to a user interface (UI) from the user, a method of receiving uttered voice corresponding to a service request from the user, and the like. In this case, the UI may be included in the input unit 140 (see FIG. 4) of the present embodiment or included in the user terminal 300. Further, in order to receive the uttered voice, a separate microphone is provided to execute a voice recognition function or the reception of the uttered voice may be implemented by a voice recognition function of the electronic device 200 mounted with the smart home monitoring apparatus 100.

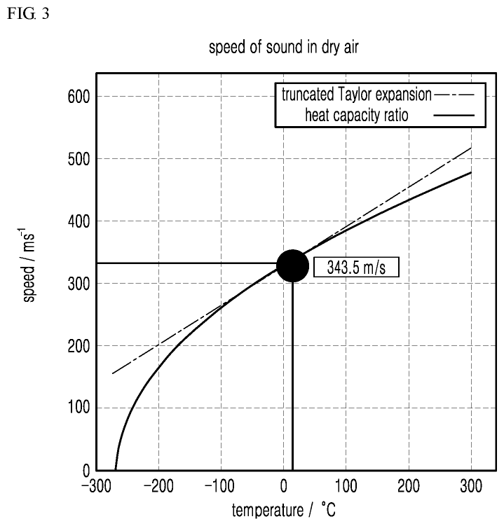

In the meantime. FIG. 3 is a view for explaining a correlation of a sound speed of a smart home monitoring apparatus according to an exemplary embodiment of the present disclosure and a temperature. In the following description, a repeated description of FIGS. 1 to 2 will be omitted. Referring to FIG. 3, it is understood that the sound speed refers to a speed of a sound which propagates through a medium and is correlated with a temperature. That is, in the air, the sound speed may be represented by a brief equation Cₐᵢᵣ=331.5+(0.6*T_{c}) m/s. Therefore, in the indoor at 20° C. (T_{c}=20), the sound speed may be calculated as approximately 343.5 m/s. That is, according to the equation, the sound speed increases in proportion to the increase of the temperature and the sound speed is 331.5 m/s at a temperature of 0° C. and whenever the temperature rises by 1° C., the sound speed increases by approximately 0.6 m/s. In the present embodiment, the smart home monitoring apparatus 100 utilizes the above-described property to periodically scan the monitoring area. Therefore, when a threshold temperature or higher at which the fire is likely to be started is detected, the smart home monitoring apparatus 100 may provide an alarm to the user. In this case, in the present embodiment, only when an abnormal state such as fire occurrence is predicted, the space to be monitored is monitored using a vision camera sensor so that the privacy problem may be overcome.

The user terminal 300 may receive a service for operating or controlling the smart home monitoring apparatus 100 through an authentication process after accessing a smart home monitoring apparatus operating application or a smart home monitoring apparatus operating site. In the present embodiment, the user terminal 300 on which the authentication process is completed may operate the smart home monitoring apparatus 100 and controls an operation of the smart home monitoring apparatus 100.

In the present embodiment, the user terminal 300 may be a desktop computer, smartphone, notebook, tablet PC, smart TV, cell phone, personal digital assistant (PDA), laptop, media player, micro server, global positioning system (GPS) device, electronic book terminal, digital broadcast terminal, navigation device, kiosk, MP3 player, digital camera, home appliance, and other mobile or immobile computing devices operated by the user, but is not limited thereto. Also, the user terminal 300 may be a wearable terminal implemented with communication function and data processing function, in the form of a watch, glasses or goggles, a hairband, a ring, or the like. The user terminal 300 is not limited to the above-mentioned devices, and thus any terminal that supports web browsing may be used as the user terminal 300.

The server 400 may be a database server which provides big data required to apply various artificial intelligence algorithms and data for operating the smart home monitoring apparatus 100. Furthermore, the server 400 may include a web server or an application server for remotely controlling the smart home monitoring apparatus 100 by using a smart home monitoring apparatus driving application or smart home monitoring apparatus driving web browser installed in the user terminal 300.

Artificial intelligence (AI) is an area of computer engineering and information technology that studies how to make computers perform things humans are capable of doing with human intelligence, such as reasoning, learning, self-improving, and the like, or how to make computers mimic such intelligent human behaviors.

In addition, artificial intelligence (AI) does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. More specifically, machine learning is a technology that investigates and builds systems, and algorithms for such systems, which are capable of learning, making predictions, and enhancing their own performance on the basis of experiential data. Machine learning algorithms, rather than only executing rigidly-set static program commands, may be used to take an approach that builds models for deriving predictions and decisions from inputted data.

The server 400 may receive and analyze the service request information from the smart home monitoring apparatus 100 and generates service response information corresponding to the service request information to transmit the service response information to the smart home monitoring apparatus 100. Specifically, the server 400 may receive an uttered voice corresponding to the user's service request from the smart home monitoring apparatus 100 and generate an uttered voice processing result as the service response information through the voice recognition processing to provide the processing result to the smart home monitoring apparatus 100. Here, in accordance with the processing capability of the smart home monitoring apparatus 100, the uttered voice corresponding to the above-described user's service request is recognized in the smart home monitoring apparatus 100 and the processing result may be generated as the service response information.

The network 500 may connect the smart home monitoring apparatus 100, the electronic device 200, the user terminal 300, and the server 400 to each other. The network 500 may include, for example, wired networks such as local area networks (LANs), wide area networks (WANs), metropolitan area networks (MANs), integrated service digital networks (ISDNs), and the like or wireless networks such as wireless LANs, CDMA, Bluetooth, satellite communication, and the like, but the scope of the present disclosure is not limited thereto. Also, the network 500 may transmit or receive data using short-range communication and/or long-range communication technologies. Here, the short-range communications may include Bluetooth, radio frequency identification (RFID), infrared data association (IrDA), ultra-wideband (UWB), ZigBee, and wireless fidelity (Wi-Fi) technology, and the long-distance communications may include code division multiple access (CDMA), frequency division multiple access (FDMA), time division multiple access (TDMA), orthogonal frequency division multiple access (OFDMA), and single carrier frequency division multiple access (SC-FDMA) technology.

The network 500 may include a connection of network elements such as a hub, bridge, router, switch, and gateway. The network 500 may include one or more connected networks, for example, a multi-network environment including a public network such as the Internet and a private network such as a secure corporate private network. Access to the network 500 may be provided through one or more wire-based or wireless access networks. Furthermore, the network 500 may support the Internet of things (IoT) for exchanging and processing information between distributed elements such as things or the like and/or 5G communication.

FIG. 4 is a schematic block diagram of a smart home monitoring apparatus according to an exemplary embodiment of the present disclosure. Hereinafter, a repeated description of FIGS. 1 to 3 will be omitted.

Referring to FIG. 4, the smart home monitoring apparatus 100 may include a communication unit 110, a fusion sensor unit 120, a memory 130, an input unit 140, an output unit 150, a processing unit 160, and a main controller 170.

The communication unit 110 may interwork with the network 500 to provide a communication interface required for providing, in a form of packet data, transmission/reception signals between the smart home monitoring apparatus 100, the electronic device 200, the user terminal 300, and/or the server 400. Furthermore, the communication unit 110 may support a variety of object-to-object intelligent communication (Internet of things (IoT), Internet of everything (IoE), Internet of small things (IoST), etc.), and may support machine to machine (M2M) communication, vehicle to everything (V2X) communication, device to device (D2D) communication, etc.

The fusion sensor unit 120 may be configured to essentially include an inaudible sound wave sensor 122 and a vision camera sensor 124. In addition, among sensors which are not exemplified, an infrared sensor or a temperature sensor may be added to the fusion sensor unit 120. In the present embodiment, the inaudible sound wave sensor 122 may include a first inaudible sound wave sensor which transmits a first inaudible sound wave signal to the monitoring area in all directions to receive a first inaudible sound wave echo signal and a second inaudible sound wave sensor which transmits a second inaudible sound wave signal to the monitoring area in all directions to receive a second inaudible sound wave echo signal. In this case, the first inaudible sound wave sensor may be an ultrasonic sensor and the second inaudible sound wave sensor may be an infrasonic sensor.

In the present embodiment, the ultrasonic sensor may be mainly used to detect an object in a long distance. The ultrasonic sensor radiates a high frequency signal having a short wavelength with a regular time interval to the outside such that the radiated signal propagates in the air at a sound speed to reach a target object. The ultrasonic sensor may include a transmitting unit and a receiving unit to determine presence of an object depending on whether the ultrasonic wave radiated from the transmitting unit is reflected by the object to be received by the receiving unit and calculates a distance from the object using an ultrasonic wave radiating time and an ultrasonic wave receiving time. The ultrasonic sensor may calculate a distance from a reference point to a target object using a time taken to receive an echo signal of the radiated signal which hits the target object and then returns. Further, the ultrasonic sensor may compare an ultrasonic wave radiated from the transmitting unit and an ultrasonic wave received by the receiving unit to detect information on a size of the object. For example, as more ultrasonic waves are received by the receiving unit, it is determined that the size of the object is large. That is, the ultrasonic sensor may detect the object based on the ultrasonic wave and detects a position of the detected object, a distance from the detected object, and a relative speed. In the meantime, the ultrasonic sensor may have the same element for both the transmitting unit which transmits the ultrasonic wave and the receiving unit which receives the ultrasonic wave and a material of the ultrasonic sensor may include a magnetostrictive material (for example, ferrite) or a voltage or electrostrictive material (Rochelle salt, barium titanate, etc.).

Further, in the present embodiment, the infrasonic wave refers to a sound wave having a frequency of an audio frequency or less. The infrasonic wave may be produced by shaking arms or shaking objects, instead of making a sound using a mouth. The infrasonic sensor includes a transmitting unit and the receiving unit and may determine the motion of the object by determining whether the infrasonic wave radiated from the transmitting unit is reflected by the object to be received by the receiving unit. That is, the infrasonic wave is produced in accordance with the motion of the object so that the infrasonic sensor may detect a subtle motion of the object.

Further, the fusion sensor unit 120 includes the vision camera sensor 124 and the vision camera sensor 124 may refer to a sensor which handles a task, which is performed by a human while watching it, using a camera and a computer. That is, image information obtained from the vision camera sensor 124 is analyzed and processed by a computer (or a main controller). However, in the present embodiment, the vision camera sensor 124 may include a camera sensor which only photographs an image. In the present embodiment, the vision camera sensor 124 may photograph an image in the monitoring area to generate a spatial map of the monitoring area. That is, in the present embodiment, a distance of the fixed object in the monitoring area is recognized by the vision camera sensor 124 to obtain distance information of the fixed object. Further, the vision camera sensor 124 may photograph an image in the monitoring area to identify whether an abnormal state occurs. That is, in the present embodiment, an image of an abnormal state occurrence predicting zone (for example, fire occurrence) is obtained by the vision camera sensor 124 and the obtained image and a previously stored abnormal state image (for example, a fire image) are compared to determine whether the abnormal state occurs.

The memory 130 may store information that supports various functions of the smart home monitoring apparatus 100. The memory 130 may store a plurality of application programs (or applications) driven in the smart home monitoring apparatus 100, information for operations of the smart home monitoring apparatus 100, and commands. At least a portion of application programs may be downloaded from an external server through wireless communication. Further, the memory 130 may store information on one or more users who perform the interaction with the smart home monitoring apparatus 100. The user information may include face information and body shape information (for example, photographed by the vision camera sensor 124) and voice information which can be used to identify the recognized user.

Further, a wake-up word which drives the smart home monitoring apparatus 100 is stored in the memory 130 so that when the user utters the wake-up word, the processing unit 160 recognizes the wake-up word to change an inactive state of the smart home monitoring apparatus 100 into an active state. Further, the memory 130 may store information on a task which needs to be performed by the smart home monitoring apparatus 100 in response to the voice command (for example, a command for controlling the smart home monitoring apparatus 100) of the user. Further, in the present embodiment, the memory 130 may store overall operation information of the smart home monitoring apparatus 100, performance information of the electronic device 200, user's feature information (for example, face information or voice information) which specifies the user, and a mode and an option of the smart home monitoring apparatus 100 to be set by a specific user. Here, the mode and the option of the smart home monitoring apparatus 100 may refer to a setting mode such as a fire detecting mode, a trespasser monitoring mode, and a pet monitoring mode and a setting option such as a temperature to determine fire in the fire detecting mode or a moving amount of an object to determine stranger's trespassing in the trespasser detecting mode. Further, the performance information of the electronic device 200 may include output strength information, information on the number of channels, and other various information representing a driving performance.

In the present embodiment, the memory 130 may perform a function of temporarily or permanently store data processed by the main controller 170. Here, the memory 130 may include magnetic storage media or flash storage media, but the scope of the present disclosure is not limited thereto. The memory 130 may include an embedded memory and/or an external memory and also include a volatile memory such as a DRAM, an SRAM, or an SDRAM, a non-volatile memory such as an one time programmable ROM (OTPROM), a PROM, an EPROM, an EEPROM, a mask ROM, a flash ROM, an NAND flash memory, or an NOR flash memory, a flash drive such as an SSD, a compact flash (CF) card, an SD card, a micro-SD card, a mini-SD card, an Xd card, or a memory stick, or a storage drive such as a HDD.

In the present embodiment, the input unit 140 may include all input means for obtaining information of the smart home monitoring apparatus 100. For example, the input unit may include a microphone (not illustrated) for voice recognition and a user input UI (not illustrated). The microphone may receive an uttering voice uttered by the user toward the smart home monitoring apparatus 100 under the control of the main controller 170. Further, in the present embodiment, a plurality of microphones may be provided to more accurately receive the uttering voice of the user. Here, the plurality of microphones may be disposed to be spaced apart from each other in different positions and process the received uttering voice of the user as an electrical signal. In the present embodiment, a voice recognition unit (not illustrated) may be included to recognize the uttering voice of the user received by the microphone. The voice recognition unit may use various noise removing algorithms to remove noises generated during a process of receiving the uttering voice of the user. As a selective embodiment, the voice recognition unit may include various components for processing a voice signal, such as a filter (not illustrated) which removes the noise at the time of receiving the uttering voice of the user and an amplifier (not illustrated) which amplifies and outputs a signal output from the filter. However, the microphone is merely an example, so that the position and the implementing method are not limited and an input means for inputting an audio signal may be borrowed without limitation.

The user input UI is a component which allows the user to input information regarding an overall operation and control of the smart home monitoring apparatus 100. That is, the user input UI is a component for interfacing with the user. Therefore, in the present embodiment, the mode and the option of the smart home monitoring apparatus 100 may be input by the input unit 140.

In the present embodiment, the output unit 150 may include all output means for outputting information of the smart home monitoring apparatus 100. For example, the output unit 150 may include a speaker (not illustrated) and an output UI (not illustrated). The speaker may output information regarding the operation of the smart home monitoring apparatus 100 as auditory data. That is, the speaker may output a notifying message such as an alarm, an operation mode, an operation state, or an error state, information corresponding to a voice command of the user, and a processing result corresponding to the user's voice command as audio, in accordance with the control of the main controller 170. Further, the speaker may convert an electrical signal from the main controller 170 into an audio signal to output the audio signal. The speaker may output an audio signal (for example, music play) from a device which wire-based or wirelessly communicates with the smart home monitoring apparatus 100. However, the speaker is merely an example, so that the position and the implementing method are not limited and all output means for outputting an audio signal may be included.

The output UI is a component which allows the user to output information regarding an overall operation and control of the smart home monitoring apparatus 100. That is, the output UI is a component for interfacing with the user. Therefore, in the present embodiment, the mode and the option of the smart home monitoring apparatus 100 may be output by the output unit 150.

That is, the UI may include the input UI and the output UI and allow the user not only to input information related to the smart home monitoring apparatus 100, but also to check information related to the smart home monitoring apparatus 100. In other words, the UI is a component for interfacing with the user. In the present embodiment, the UI may refer to a control panel which is capable of inputting and outputting information to control the smart home monitoring apparatus 100. To this end, the UI may be configured by a touch recognition display controller or other various input/output controllers. For example, the touch recognition display controller may provide an output interface and an input interface between the apparatus and the user. The touch recognition display controller may transmit and receive an electrical signal to and from the main controller 170. Further, the touch recognition display controller displays a visual output to the user and the visual output includes a text, a graphic, an image, a video, and a combination thereof. Such an UI may be a predetermined display member such as an organic light emitting display (OLED), a liquid crystal display (LCD), or a light emitting display (LED) which is capable of recognizing the touch.

In the meantime, in the present embodiment, the input unit 140 and the output unit 150 may be implemented in the user terminal 300 (see FIG. 1). For example, in the present embodiment, user input and information output may be allowed through a smart home monitoring apparatus operating application of the user terminal or an access screen of a smart home monitoring apparatus operating site.

The processing unit 160 may generate a spatial map of the monitoring area to be monitored by the smart home monitoring apparatus 100 and predict whether an abnormal state occurs in the monitoring area through the first inaudible sound wave echo signal, based on the spatial map of the monitoring area. Further, when the abnormal state occurrence of the monitoring area is predicted, the processing unit 160 may obtain and analyze an image obtained by photographing the monitoring area using the vision camera.

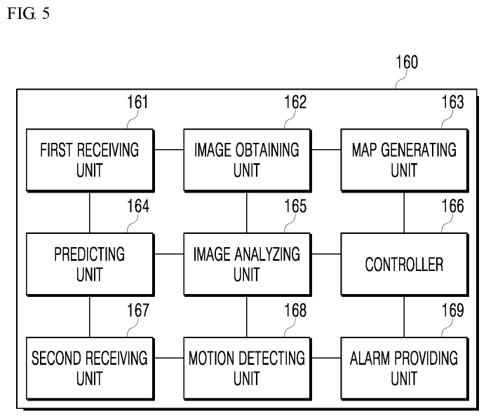

In the present embodiment, the processing unit 160 may be equipped at the outside of the main controller 170 as illustrated in FIG. 4 or equipped in the main controller 170 to operate as the main controller 170 or equipped in the server 400 of FIG. 1. Hereinafter, a detailed operation of the processing unit 160 will be described with reference to FIG. 5.

The main controller 170 is a sort of central processing units and may drive control software loaded in the memory 130 to control an overall operation of the smart home monitoring apparatus 100. In the present embodiment, the main controller 170 may generate the spatial map of the monitoring area using the fusion sensor unit 120 and predict whether the abnormal state occurs in the monitoring area based on the spatial map of the monitoring area. That is, the main controller 170 may obtain initial information of a first inaudible sound wave echo signal by scanning the monitoring area using the fusion sensor unit 120 and obtain distance information of the fixed object through the vision camera, in order to generate the spatial map. Further, the main controller 170 may receive a second inaudible sound wave echo signal through the fusion sensor unit 120 to detect whether there is a motion of the object in the monitoring area. That is, the main controller 170 may perform the monitoring through the fusion sensor unit 120 in accordance with the setting related to the operation and the control of the smart home monitoring apparatus 100 input from the input unit 140. Further, the main controller 170 may output the monitoring result through the output unit 150. For example, when the main controller 170 determines that fire occurs, the main controller 170 may output an alarm including one or more contents of a fire image, a cause of the fire, and a tire extinguishing plan.

Further, the main controller 170 may output a monitoring result through one or more of the communication unit 110 and the output unit 150. Further, when the setting related to the operation and the control of the smart home monitoring apparatus 100 is input from the user through one or more of the communication unit 110 and the input unit 140, the main controller 170 may analyze or output data obtained from the fusion sensor unit 120.

Here, the main controller 170 may include a device of any kind capable of processing data, such as a processor. Here, the term “processor” may represent, for example, a hardware-embedded data processing device having a physically structured circuit to execute functions expressed as instructions or codes included in a program. Examples of the data processing device built in a hardware include, but are not limited to, processing devices such as a microprocessor, a central processing unit (CPU), a processor core, a multiprocessor, an application-specific integrated circuit (ASIC), and a field programmable gate array (FPGA).

In the present embodiment, the main controller 170 performs machine learning such as deep learning for creation of a spatial map of the smart home monitoring apparatus 100, detection of a motion of an object, comparison of an image of an abnormal state occurrence, obtaining of a voice command, an operation of the smart home monitoring apparatus 100 corresponding to a voice command, and a user customized operation and the memory 130 stores data used for the machine learning and result data.

A deep learning technology, which is a type of machine learning, may perform learning to a deep level in stages on the basis of data. As the number of layers in deep learning increases, the deep learning network may acquire a collection of machine learning algorithms that extract core data from multiple datasets.

Deep learning structures may include an artificial neural network (ANN), and may include a deep neural network (DNN) such as a convolutional neural network (CNN), a recurrent neural network (RNN), a deep belief network (DBN), and the like. The deep learning structure according to the present embodiment may use various structures well known in the art. For example, the deep learning structure according to the present disclosure may include a CNN, an RNN, a DBN, and the like. RNN is an artificial neural network structure which is formed by building up layers at each instance, and which is heavily used in natural language processing and the like and elective for processing time-series data which vary over a course of time. A DBN includes a deep learning structure formed by stacking up multiple layers of a deep learning scheme, restricted Boltzmann machines (RBM). A DBN has the number of layers formed by repeating RBM training. CNN includes a model mimicking a human brain function, built on the assumption that when a person recognizes an object, the brain extracts basic features of the object and recognizes the object based on the results of complex processing in the brain.

Further, the artificial neural network may be trained by adjusting weights of connections between nodes (if necessary, adjusting bias values as well) so as to produce a desired output from a given input. Also, the artificial neural network can continuously update the weight values through learning. Furthermore, methods such as back propagation may be used in training the artificial neural network.

That is, an artificial neural network may be installed in the smart home monitoring apparatus 100, and the main controller 170 may include an artificial neural network, for example, a deep neural network (DNN) such as CNN, RNN, or DBN. Therefore, the main controller 170 may train the deep neural network for creation of a spatial map of the smart home monitoring apparatus 100, detection of a motion of an object, comparison of an image of an abnormal state occurrence, obtaining of a voice command, an operation of the smart home monitoring apparatus 100 corresponding to a voice command, and a user customized operation. Both unsupervised learning and supervised learning may be used as a machine learning method of the artificial neural network. The main controller 170 may control so as to update an artificial neural network structure after learning according to a setting.

FIG. 5 is a schematic block diagram of a processing unit of a smart home monitoring apparatus according to an exemplary embodiment of the present disclosure. Hereinafter, a repeated description of FIGS. 1 to 4 will be omitted. Referring to FIG. 5, the processing unit 160 includes a first receiving unit 161, an image obtaining unit 162, a map generating unit 163, a predicting unit 164, an image analyzing unit 165, a controller 166, a second receiving unit 167, a motion detecting unit 168, and an alarm providing unit 169.

The first receiving unit 161 may receive a signal returning from a first inaudible sound wave signal which is transmitted to the monitoring area in all directions by the inaudible sound wave sensor 122 (see FIG. 4), that is, a first inaudible sound wave echo signal. That is, the first receiving unit 161 may receive an ultrasonic echo signal which returns from the entire monitoring area.

Further, the image obtaining unit 162 may obtain an image such as an image obtained by entirely photographing the monitoring area by the vision camera sensor 124 (see FIG. 4) and/or an image obtained by photographing an area of the monitoring area in which the abnormal state is predicted.

In the meantime, in the present embodiment, a spatial map for the monitoring area may be generated based on the first inaudible sound wave echo signal for the monitoring area received by the first receiving unit 161 and the image for the entire monitoring area obtained by the image obtaining unit 162. That is, the map generating unit 163 generates the spatial map of the monitoring area and the spatial map generated by the map generating unit 163 may serve as initial reference data of the smart home monitoring apparatus 100. In other words, in the present embodiment, a situation indicating whether a temperature abnormally rises, what is a fixed object in the monitoring area, or whether a motion which is not the fixed object is generated in the monitoring area may be analyzed and determined with respect to the spatial map generated by the map generating unit 163. In the present embodiment, although the map generating unit 163 generates the map by itself, a map which is generated at the outside may be received through a server or a communication unit.

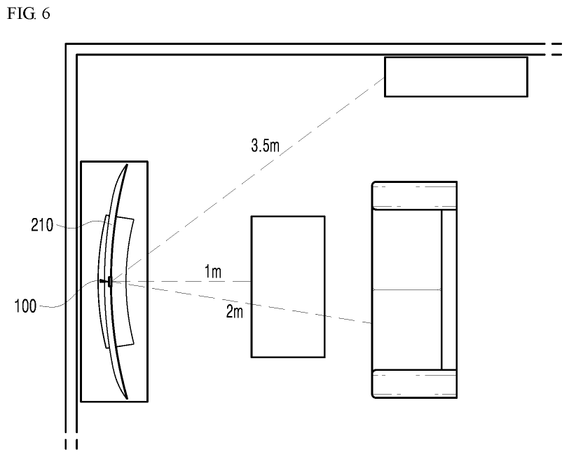

FIG. 6 is an exemplary diagram of schematically illustrating a spatial map of a smart home monitoring apparatus according to an exemplary embodiment of the present disclosure. Hereinafter, a repeated description of FIGS. 1 to 5 will be omitted. Referring to FIG. 6, in the present embodiment, the smart home monitoring apparatus 100, for example, may be equipped at the upper edge of the TV 210 or only the fusion sensor unit 120 (see FIG. 2) may be equipped in the TV 210. That is, the present embodiment is not limited thereto and the spatial map for the monitoring area may be generated by the inaudible sound wave sensor 122 (see FIG. 2) and the vision camera sensor 124 (see FIG. 2) of the fusion sensor unit. That is, the map generating unit 163 scans the monitoring area using the first inaudible sound wave signal of the inaudible sound wave sensor to obtain initial information of the first inaudible sound wave echo signal from the monitoring area. The map generating unit 163 may recognize a distance of the fixed object in the monitoring area by the vision camera to obtain distance information of the fixed object. That is, the map generating unit 163 scans the monitoring area using the ultrasonic signal to identify the fixed object in the monitoring area. Further, the map generating unit 163 may obtain an image obtained by photographing in the monitoring area, for example, using a vision depth camera to recognize the distance from the fixed object. In the present embodiment, two vision camera sensors 124 are equipped to obtain the distance of the object by means of parallax of a left image of the object photographed by a left camera and a right image of the object photographed by a right camera. More specifically, the map generating unit 163 calculates a value obtained by multiplying an interval between the left camera and the right camera and a focal distance of a lens and then dividing the multiplied value by a parallax (a difference of a position or a direction of the object in accordance with an observation position) of the left image and the right image, as a distance of the object. As illustrated in FIG. 6, the spatial map may include a fixed object such as a table, a sofa, and a bookshelf and may be generated with a distance to the table of 1 m, a distance to the sofa of 2 m, and a distance to the bookshelf of 3.5 m. In the meantime, in the present embodiment, even though the spatial map is generated by the ultrasonic wave and the camera image, the distance to the object may be measured and the spatial map may be generated only using the ultrasonic wave. However, in the present embodiment, the distance to the fixed object is measured and the spatial map is generated using the ultrasonic wave and the camera image so that the accuracy of the spatial map may be further improved.

The predicting unit 164 may predict a possibility of abnormal state occurrence of the monitoring area through the first inaudible sound wave echo signal, based on the spatial map of the monitoring area. Here, the prediction of the possibility of abnormal state occurrence refers to a state in which there is a possibility of abnormal state occurrence before the abnormal state occurs. Further, for an initial predetermined time after the abnormal state occurs, it may be classified as an abnormal state possibility predicting state. In this case, with regard to the state in which there is a possibility of abnormal state occurrence, for example, a temperature range or a range of the motion of the object may be set in advance by the user or in a design step.

The predicting unit 164 may obtain a speed of the first inaudible sound wave according to the first inaudible sound wave echo signal and identify a temperature of an arbitrary part in the monitoring area by a correlation between the speed of the first inaudible sound wave and the temperature. Further, the predicting unit 164 may predict the possibility of abnormal state based on a temperature change for the arbitrary part in the monitoring area. That is, the predicting unit 164 may receive the first inaudible sound wave echo signal for a first inaudible sound wave signal transmitted to the monitoring area in all directions from the first receiving unit 161 and monitor the speed of the first inaudible sound wave (ultrasonic wave) based on the distance and the temperature in the monitoring area (an arbitrary area or a fixed object area) identified by the first inaudible sound wave echo signal. Further, the predicting unit 164 may predict a possibility of abnormal state occurrence (for example, fire occurrence) when a temperature change from an initial temperature of the fixed object is equal to or higher than a predetermined reference value based on the spatial map or a temperature of the fixed object reaches a predetermined setting temperature. Further, the predicting unit 164 may predict the possibility of fire occurrence of the corresponding part when a temperature for an arbitrary part in the monitoring area other than the fixed object area reaches a predetermined setting temperature or a temperature change for the arbitrary part in the monitoring area is equal to or higher than the predetermined reference value.

In the meantime, in the present embodiment, when the predicting unit 164 predicts the possibility of abnormal state occurrence such as tire occurrence, whether an abnormal state occurs in the monitoring area is determined, after obtaining an image by photographing the monitoring area using the vision camera. In another aspect, even though the possibility of abnormal state occurrence is not predicted, the monitoring area may be monitored using the vision camera. However, in order to prevent a privacy problem from occurring due to the camera, only when the possibility of abnormal state occurrence is predicted through the ultrasonic wave, the monitoring area may be desirably monitored using the vision camera. In this case, in the present embodiment, after obtaining an image by photographing the monitoring area using the vision camera, the image may be compared with the abnormal state image to perform the cross-checking using the vision camera.

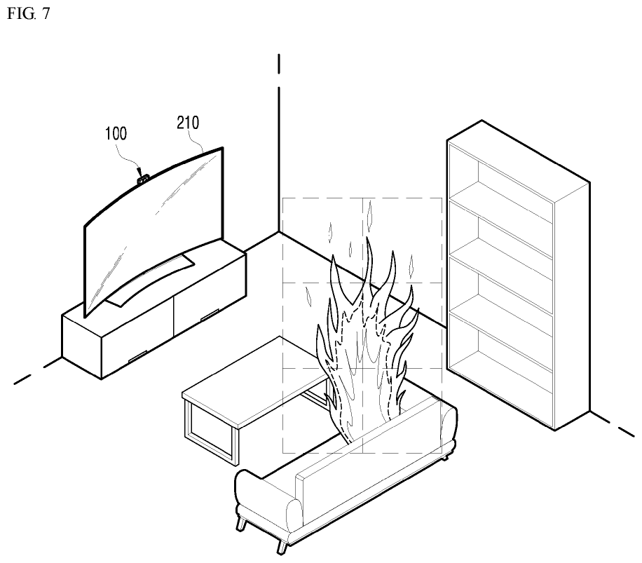

FIG. 7 is an exemplary diagram for explaining analysis of a fire image of a smart home monitoring apparatus according to an exemplary embodiment of the present disclosure. Hereinafter, a repeated description of FIGS. 1 to 6 will be omitted. Referring to FIG. 7, the image analyzing unit 165, for example, may compare an image which is trained and stored as a fire image with a currently photographed image. For example, the image analyzing unit 165 may extract features of an image (an image of an area where fire occurrence is predicted) obtained by the image obtaining unit 162 using the vision camera sensor and compare the image with the learned and stored fire image and analyze the image. For example, when a temperature of the sofa which is a fixed object abnormally rises as a result of monitoring the monitoring area by the smart home monitoring apparatus 100 equipped in the TV 210 or the fusion sensor unit of the smart home monitoring apparatus 100, the image analyzing unit 165 may analyze the image of the sofa part obtained by the image obtaining unit 162.

The controller 166 may determine whether an abnormal state occurs in the monitoring area based on the analysis result of the image analyzing unit 165. That is, the controller 166 compares an image photographed by the vision camera and a previously stored fire image to determine whether fire occurs. In other words, when the predicting unit 164 predicts the fire occurrence, the controller 166 may perform the cross-check to confirm whether the fire actually occurs by the image analyzing unit 165 to determine whether the fire occurs. Further, when the controller 166 determines that fire occurs, the controller 166 outputs an alarm through one or more of the output unit 150 (see FIG. 4) and the user terminal 300 (see FIG. 1). For example, the controller 166 may output the alarm through one or more of the output unit of the smart home monitoring apparatus 100 and the user terminal 300.

However, before determining the fire occurrence, the controller 166 may output the alarm in a step of predicting the fire occurrence. Further, the controller 166 may provide monitoring information of the monitoring area upon user's separate request. For example, when the user requests the monitoring information of the monitoring area through one or more of the input unit 140 (see FIG. 4) and the user terminal, the monitoring information may be provided through one or more of the output unit and the user terminal. Further, in the present embodiment, a request signal is input from the user through the input interface of the smart home monitoring apparatus 100 or the request signal is input from the user through the user terminal. Here, the monitoring information of the monitoring area may include a monitoring area monitoring screen or temperature data of the monitoring area. When an uttering voice including a request for monitoring information is received, the controller 166 may provide the monitoring information of the smart home monitoring apparatus 100. In this case, in the present embodiment, the uttering voice may be received through the input unit of the smart home monitoring apparatus 100 and also received by the AI speaker 230 or a voice receiving unit of the user terminal 300.

In the meantime, in the present embodiment, whether there is a motion of the object in the monitoring area may be detected using the second inaudible sound wave signal. In this case, the controller 166 monitors the temperature of the monitoring area to monitor whether fire occurs and when the temperature in the monitoring area or the temperature change is equal to or higher than a threshold value, detects whether there is a motion of the object in the monitoring area. In the present embodiment, the reason why the motion of the object is detected when the fire occurrence is predicted is to distinguish whether the speed of the first inaudible sound wave in accordance with the first inaudible sound wave echo signal and the temperature change of an arbitrary part in the monitoring area in accordance with the speed are caused by the motion of the object. That is, in the present embodiment, when the fire occurrence is predicted, whether there is a motion of the object is detected to distinguish whether a temperature change is caused by the tire or the motion of the object. Moreover, in the present embodiment, the moving object is analyzed and learned to identify what is the moving object and moving object information such as a sensing value of the fusion sensor unit corresponding to the moving object. For example, in the present embodiment, the moving object is analyzed and learned to detect whether there is a user in the monitoring area or whether a stranger trespasses or determine whether the fire occurs by reflecting the moving object information. That is, in the present embodiment, when the user is not in the monitoring area, a tire alarm is output or a stranger's trespassing alarm is output. Further, when the moving object is, for example, a robot cleaner or a pet, this moving object may be discerned through the learning and a temperature change range of this moving object may be learned to be applied to the spatial map for monitoring the fire occurrence. The application to the spatial map refers to prediction of the fire occurrence by reflecting the learned or stored moving object information as well as the fixed object when the fire occurrence is predicted based on the spatial map. In the present embodiment, when the fire occurrence is predicted, whether motion of the object is generated is detected and then the fire occurrence is finally determined. However, the present embodiment is not limited thereto and whether the motion of the object is generated may be detected regardless of the prediction of the fire occurrence.

In the present embodiment, whether the motion of the object is generated may be detected based on the second inaudible sound wave signal, that is, an infrasonic signal. That is, the second receiving unit 167 transmits the second inaudible sound wave signal to the monitoring area in all directions to receive a second inaudible sound wave echo signal. In other words, the second receiving unit 167 may receive a signal returning from a second inaudible sound wave signal which is transmitted to the monitoring area in all directions by the inaudible sound wave sensor 122 (see FIG. 4), that is, a second inaudible sound wave echo signal. That is, the second receiving unit 167 may receive an infrasonic echo signal which returns from the entire monitoring area.

Further, the motion detecting unit 168 may detect whether the object moves in the monitoring area by the second inaudible sound wave echo signal, based on the spatial map of the monitoring area. The infrasonic wave detects a subtle motion of the object so that it may detect a subtle motion of the object in the monitoring area.

In the present embodiment, the motion detecting unit 168 may determine that there is no motion of the object when a degree of the motion of the object detected by the second inaudible sound wave echo signal is equal to or lower than a predetermined reference value. In this case, in the present embodiment, when the user is sleeping, the motion is so subtle, so that it may be determined that there is no motion of the user and it is classified as a fixed object. However, when the degree of motion of the object is maintained to be equal to or lower than the reference value for a predetermined time or longer, the object may be classified as a fixed object. Further, in the present embodiment, when it is determined that the user is sleeping, it is determined that it is the same situation that the user is going out, to output an alarm for fire occurrence or stranger's trespassing.

That is, in the present embodiment, the motion detecting unit 168 may analyze the moving object when a degree of the motion of the object detected by the second inaudible sound wave echo signal exceeds the predetermined reference value. For example, the motion detecting unit 168 may analyze what is the moving object based on information such as a temperature, a moving speed, a degree of motion, and a size of the moving object. Therefore, the predicting unit 164 may predict the possibility of abnormal state occurrence by reflecting moving object information as a moving object analysis result. That is, in the present embodiment, for example, when the moving object is analyzed as a robot cleaner or a pet, the monitoring area may be scanned again by the inaudible sound wave sensor by reflecting the analysis.

In the meantime, in the present embodiment, when the user is located at the outside of the monitoring area, if the moving object is determined as a human as a moving object analysis result of the motion detecting unit 168, the controller 166 may determine that there is stranger's trespassing to output an alarm through one or more of the output unit and the user terminal.

The alarm providing unit 169 may provide an alarm when a possibility of fire occurrence is predicted, the tire occurrence is detected, or a stranger trespasses. In this case, for example, when the tire actually occurs, the alarm providing unit 169 may also provide the alarm to the fire station as well as the user. Further, for example, when the stranger trespasses, the alarm providing unit 169 may also provide the alarm to the police office as well as the user. The alarm providing unit 169 may provide the alarm to the user through the user terminal 300 (see FIG. 1) and provide the alarm to the corresponding public institution through a separate external communication module (not illustrated). However, the alarm providing method of the alarm providing unit 169 is not limited thereto and alarm formats such as text transmission, popup messages, or contents transmission may be allowed and is not limited thereto.

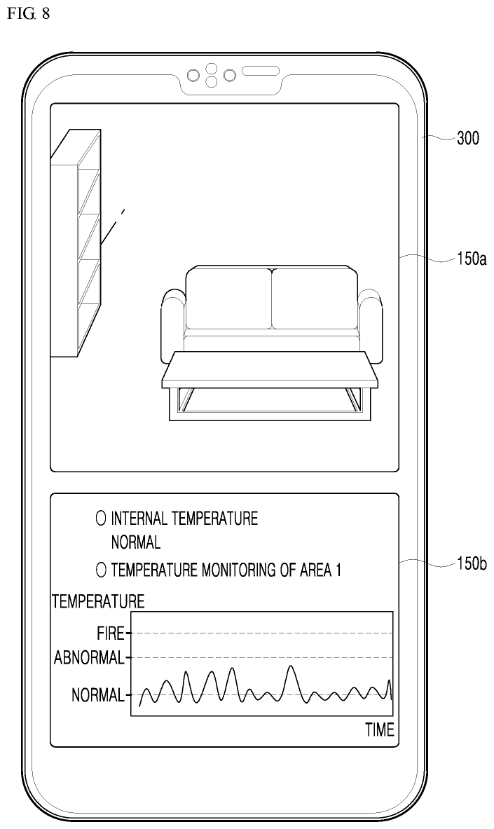

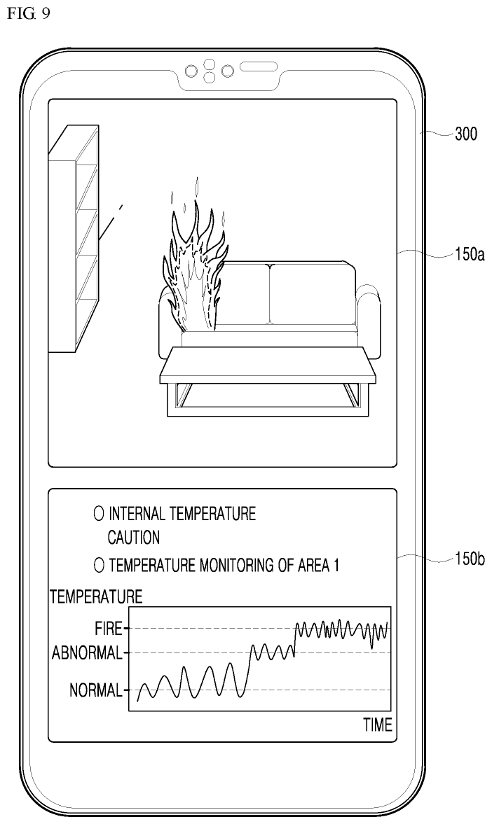

FIG. 8 is an exemplary diagram of schematically illustrating an output unit of a smart home monitoring apparatus according to an exemplary embodiment of the present disclosure and FIG. 9 is an exemplary diagram of schematically illustrating an output unit of a smart home monitoring apparatus according to an exemplary embodiment of the present disclosure when fire occurs. Hereinafter, a repeated description of FIGS. 1 to 7 will be omitted. Referring to FIGS. 8 and 9, in the present embodiment, the monitoring information and/or the alarm may be output through the user terminal 300. However, in the present embodiment, the monitoring information and/or the alarm may be output by an output means in the smart home monitoring apparatus 100 or a separate external output means. Therefore, even though in FIGS. 8 and 9, the user terminal 300 is illustrated, the output unit is not limited to the user terminal 300 and all output means may be included. Therefore, in the present embodiment, the output unit 150 may include a first control panel 150a and a second control panel 150b to output the monitoring information and/or the alarm. For example, the first control panel 150a may be a monitoring screen providing control panel which outputs a monitoring area monitoring screen and an alarm in accordance with the fire occurrence or the stranger's trespassing. Further, the first control panel 150a may output the monitoring area monitoring screen in accordance with the request signal input of the user. That is, referring to FIG. 8, a monitoring area monitoring screen is provided by the user's request signal input even though there is no fire occurrence or stranger's trespassing. Further, referring to FIG. 9, the monitoring area monitoring screen and an alarm are provided when the fire occurs. The second control panel 150b may be monitoring information providing control panel which provides monitoring area monitoring information such as internal temperature of the monitoring area and a temperature monitoring result. In this case, FIG. 8 illustrates a normal state in which the fire occurrence or the stranger's trespassing is not predicted. FIG. 9 illustrates a state in which the temperature abnormally rises to predict the possibility of fire occurrence and eventually, fire occurs to output an alarm.

In the meantime, in the present embodiment, a parameter for previously trained deep neural network learning may be collected. In this case, the parameter for deep neural network learning may include a sound speed of an ultrasonic wave for generating a spatial map, a temperature according to the sound speed, a vision camera signal, and a distance according to the signal. Further, the parameter may include an infrasonic signal for detecting a motion of the object or discerning the moving object, feature extraction data for determining an abnormal state occurrence, a voice command, an operation of the smart home monitoring apparatus 100 corresponding to the voice command, and user personalized operation data. However, in the present embodiment, the parameter for deep neural network learning is not limited thereto. In this case, in the present embodiment, in order to elaborate the learning model, data which is actually used by the user may be collected. That is, in the present embodiment, the user data may be input from the user through one or more of the input unit 140, the communication unit 110, and the user terminal 300. Further, when the user inputs a position and a distance of the fixed object and starts the operation of the smart home monitoring apparatus 100, the smart home monitoring apparatus 100 stores data such as the position, the distance, and the temperature of the fixed object in the server and/or the memory regardless of the result of the learning model. That is, in the present embodiment, the smart home monitoring apparatus 100 stores data generated when the user uses the smart home monitoring apparatus 100 in a server to configure big data and the deep learning is performed at a server stage to update the related parameter in the smart home monitoring apparatus 100 to gradually elaborate the parameter. That is, in the present embodiment, at the initial release of the smart home monitoring apparatus 100, a deep learning parameter of the laboratory condition is installed and is updated by the data which is accumulated as the user uses the home monitoring apparatus 100. Therefore, in the present embodiment, the collected data is labeled to obtain a resultant by the supervised learning and the resultant is stored in the memory of the smart home monitoring apparatus 100 so that an evolving algorithm is completed. That is, the smart home monitoring apparatus 100 collects data detected while performing the monitoring to generate a learning data set and determines a model trained by training the learning data set using a machine learning algorithm to detect whether the abnormal state occurs. Further, the smart home monitoring apparatus 100 collects the data which is actually used by the user and re-trains in the server the data to generate a re-trained model. Therefore, in the present embodiment, the data is continuously collected even after determining the data as a trained model and is re-trained by applying the machine learning model to improve the performance by the re-trained model.

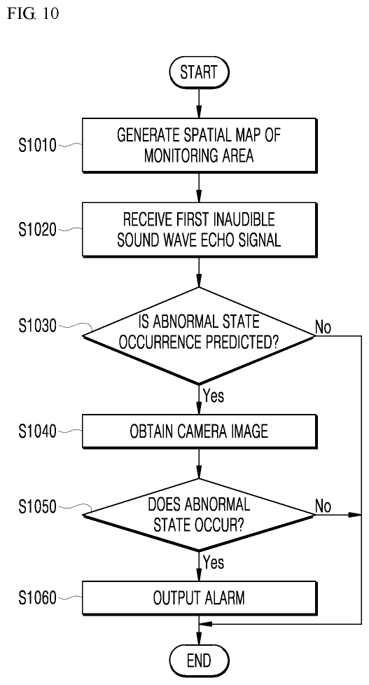

FIG. 10 is a flowchart illustrating a smart home monitoring method according to an exemplary embodiment of the present disclosure. Hereinafter, a repeated description of FIGS. 1 to 9 will be omitted.

Referring to FIG. 10, in step S1010, the smart home monitoring apparatus 100 generates a spatial map of a monitoring area. In the present embodiment, the spatial map for the monitoring area may be generated based on a first inaudible sound wave echo signal by the inaudible sound wave sensor 122 (see FIG. 4) and an image for the entire monitoring area obtained by the vision camera sensor 124 (see FIG. 4). That is, the smart home monitoring apparatus 100 generates the spatial map of the monitoring area to set the spatial map as initial reference data. In other words, in the present embodiment, a situation indicating whether a temperature abnormally rises, what is a fixed object in the monitoring area, and whether a motion, rather than the fixed object, is generated in the monitoring area may be analyzed and determined with respect to the spatial map. The smart home monitoring apparatus 100 scans the monitoring area using the first inaudible sound wave signal of the inaudible sound wave sensor to obtain initial information of the first inaudible sound wave echo signal from the monitoring area. Further, the smart home monitoring apparatus 100 may recognize a distance of the fixed object in the monitoring area by the vision camera sensor to obtain distance information of the fixed object. That is, the smart home monitoring apparatus 100 scans the monitoring area using the ultrasonic signal to identify the fixed object in the monitoring area and obtains an image obtained by photographing in the monitoring area using a vision depth camera to recognize the distance from the fixed object. In the meantime, in the present embodiment, even though the spatial map is generated by the ultrasonic wave and the camera image, the distance to the object may be measured and the spatial map may be generated only using the ultrasonic wave. However, in the present embodiment, the distance to the fixed object is measured and the spatial map is generated using the ultrasonic wave and the camera image so that the accuracy of the spatial map may be further improved.

In step S1020, the smart home monitoring apparatus 100 receives the first inaudible sound wave echo signal. In this case, the smart home monitoring apparatus 100 obtains a speed of the first inaudible sound wave according to the first inaudible sound wave echo signal and identifies a temperature of an arbitrary part in the monitoring area by a correlation between the speed of the first inaudible sound wave and the temperature. That is, in the present embodiment, the temperature is identified in accordance with the first inaudible sound wave, that is, a sound speed of the ultrasonic wave and the sound speed refers to a speed at which a sound propagates in a medium. In the air, the sound speed may be represented by a brief equation Cₐᵢᵣ=331.5+(0.6*T_{c}) m/s. According to the equation, in the indoor at 20° C. (T_{c}=20), the sound speed may be calculated as approximately 343.5 m/s and it is understood that as the temperature rises, the sound speed is increased in proportion to the increase of the temperature.

In step S1030, the smart home monitoring apparatus 100 predicts the possibility of abnormal state occurrence of the monitoring area based on the first inaudible sound wave echo signal of the first inaudible sound wave signal transmitted to the monitoring area in all directions. That is, the smart home monitoring apparatus 100 may predict a possibility of abnormal state occurrence of the monitoring area through the first inaudible sound wave echo signal, based on the spatial map of the monitoring area. In other words. the smart home monitoring apparatus 100 obtains a speed of the first inaudible sound wave according to the first inaudible sound wave echo signal and identifies a temperature of an arbitrary part in the monitoring area by a correlation between the speed of the first inaudible sound wave and the temperature. Further, the smart home monitoring apparatus 100 may predict the possibility of abnormal state occurrence based on a temperature change for the arbitrary part in the monitoring area. That is, the smart home monitoring apparatus 100 monitors the speed of the first inaudible sound wave (ultrasonic wave) and a temperature based on a distance in the monitoring area (an arbitrary area or a fixed object area) identified by the first inaudible sound wave echo signal. Further, the smart home monitoring apparatus 100 may predict a possibility of abnormal state occurrence (for example, fire occurrence) when a temperature change from an initial temperature of the fixed object is equal to or higher than a predetermined reference value based on the spatial map or a temperature of the fixed object reaches a predetermined setting temperature. Further, the smart home monitoring apparatus 100 may predict the possibility of fire occurrence of the corresponding part when a temperature for an arbitrary part in the monitoring area other than the fixed object area reaches a predetermined setting temperature or a temperature change for the arbitrary part in the monitoring area is equal to or higher than the predetermined reference value.

In step S1040, the smart home monitoring apparatus 100 obtains a camera image (Yes in step S1030) after predicting the possibility of abnormal state such as fire occurrence. In this case, the smart home monitoring apparatus 100 may photograph an image in the monitoring area by the vision camera sensor to confirm whether the abnormal state occurs. That is, in the present embodiment, an image of an abnormal state occurrence predicting zone (for example, fire occurrence) is obtained by the vision camera sensor 124 and the obtained image and a previously stored abnormal state image (for example, a fire image) are compared to determine whether the abnormal state, such as fire occurrence, occurs.

In step S1050, the smart home monitoring apparatus 100 compares the image obtained by the vision camera sensor 124 and a previously stored abnormal state image to determine fire occurrence. The smart home monitoring apparatus 100 may compare an image which is trained and stored as a fire image and a currently photographed image. For example, the smart home monitoring apparatus 100 may extract features of an image (an image of an area where fire occurrence is predicted) obtained by the image obtaining unit 162 using the vision camera sensor and compare the image with the learned and stored fire image and analyze the image. When the fire occurrence is predicted, the smart home monitoring apparatus 100 performs cross-checking to confirm whether the tire actually occurs by the image analysis to determine whether the fire occurs.

In step S1060, when the first occurrence is determined, the smart home monitoring apparatus 100 outputs an alarm for the situation in which the tire occurs (Yes in step S1050). When the smart home monitoring apparatus 100 determines that fire occurs, the smart home monitoring apparatus 100 outputs an alarm through one or more of the output unit 150 (see FIG. 4) and the user terminal 300 (see FIG. 1). For example, the controller 166 may output the alarm through one or more of the output unit of the smart home monitoring apparatus 100 and the user terminal 300. In another aspect, before determining the fire occurrence, the smart home monitoring apparatus 100 may output the alarm in a step of predicting the fire occurrence. Further, the smart home monitoring apparatus 100 may provide monitoring information of the monitoring area upon user's separate request. For example, when the user requests the monitoring information of the monitoring area through one or more of the input unit 140 (see FIG. 4) and the user terminal, the smart home monitoring apparatus 100 may provide the monitoring information through one or more of the output unit and the user terminal.

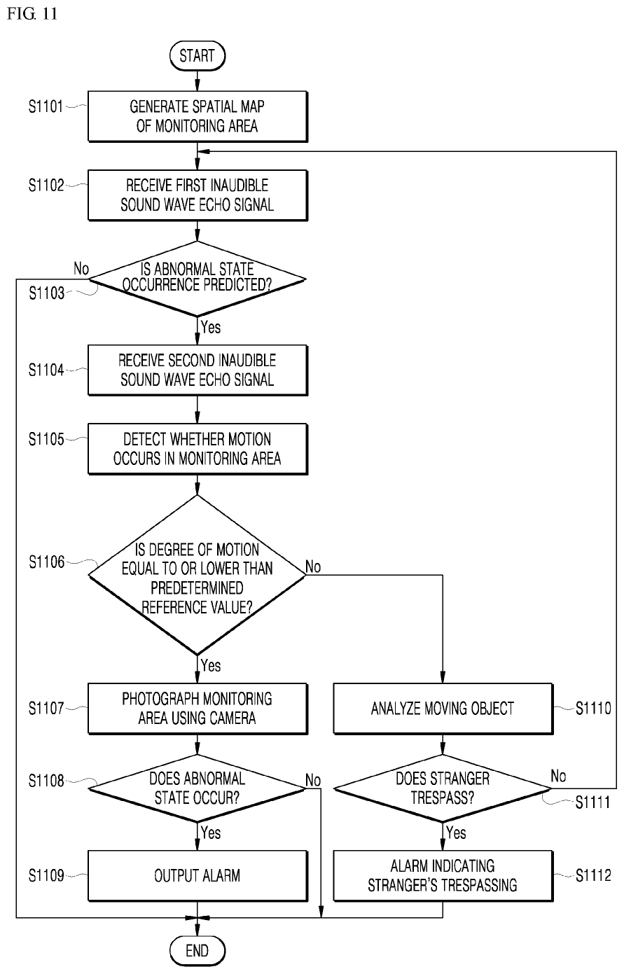

FIG. 11 is a flowchart illustrating a smart home monitoring method to which moving object analysis of a smart home monitoring apparatus according to an exemplary embodiment of the present disclosure is applied. Hereinafter, a repeated description of FIGS. 1 to 10 will be omitted.

Referring to FIG. 11, in step S1101, the smart home monitoring apparatus 100 generates a spatial map of a monitoring area. The smart home monitoring apparatus 100 scans the monitoring area through the first inaudible sound wave signal of the inaudible sound wave sensor and recognizes a distance from the fixed object in the monitoring area through the vision camera sensor to obtain distance information of the fixed object, thereby generating a spatial map of the monitoring area. In another aspect, in the present embodiment, a map generated at the outside may also be received in addition to the map which is generated using its own unit.

In step S1102, the smart home monitoring apparatus 100 receives the first inaudible sound wave echo signal. In this case, the smart home monitoring apparatus 100 obtains a speed of the first inaudible sound wave according to the first inaudible sound wave echo signal and identifies a temperature of an arbitrary part in the monitoring area by a correlation between the speed of the first inaudible sound wave and the temperature.

In step S1103, the smart home monitoring apparatus 100 predicts the possibility of abnormal state occurrence of the monitoring area based on the first inaudible sound wave echo signal of the first inaudible sound wave signal transmitted to the monitoring area in all directions. That is, the smart home monitoring apparatus 100 may predict a possibility of abnormal state occurrence of the monitoring area through the first inaudible sound wave echo signal, based on the spatial map of the monitoring area.

In step S1104, when the possibility of abnormal state is predicted, the smart home monitoring apparatus 100 receives a second inaudible sound wave echo signal (Yes in step S1103). That is, the smart home monitoring apparatus 100 may receive a signal returning from a second inaudible sound wave signal which is transmitted to the monitoring area in all directions by the inaudible sound wave sensor 122 (see FIG. 4), that is, a second inaudible sound wave echo signal. Therefore, the smart home monitoring apparatus 100 may receive an infrasonic echo signal which returns from the entire monitoring area.

In step S1105 the smart home monitoring apparatus 100 detects whether there is a motion of the object in the monitoring area using the second inaudible sound wave signal. In this case, the smart home monitoring apparatus 100 monitors the temperature of the monitoring area to monitor whether fire occurs and when the temperature in the monitoring area or the temperature change is equal to or higher than a threshold value, detects whether a motion of the object occurs in the monitoring area. In the present embodiment, the reason why the motion of the object is detected when the lire occurrence is predicted is to distinguish whether the speed of the first inaudible sound wave in accordance with the first inaudible sound wave echo signal and the temperature change of an arbitrary part in the monitoring area in accordance with the speed is caused by the motion of the object. That is, in the present embodiment, when the fire occurrence is predicted, whether there is a motion is detected to distinguish whether a temperature change is caused by the fire or the motion. Moreover, in the present embodiment, the moving object is analyzed and learned to figure out what is the moving object and moving object information such as a sensing value of the fusion sensor unit corresponding to the moving object. In the present embodiment, when the moving object is a robot cleaner or a pet, this moving object may be discerned through the learning and a temperature change range of this moving object may be learned to be applied to the spatial map for monitoring the fire occurrence. The application to the spatial map refers to prediction of the fire occurrence by reflecting the learned or stored moving object information as well as the fixed object when the fire occurrence is predicted based on the spatial map.

In step S1106, when the degree of motion of the object detected by the second inaudible sound wave echo signal is equal to or lower than a predetermined reference value, the smart home monitoring apparatus 100 determines that there is no motion.

In this case, in the present embodiment, when the user is sleeping, the motion is so subtle, so that it may be determined that there is no motion of the user and it is classified as a fixed object. However, when the degree of motion of the object is maintained to be equal to or lower than the reference value for a predetermined time or longer, the object may be classified as a fixed object. Further, in the present embodiment, when it is determined that the user is sleeping, it is determined that it is the same situation that the user is going out, to output an alarm for fire occurrence or stranger's trespassing.

In step S1107, when the degree of motion of the object is maintained to be equal to or lower than the reference value as a result of detecting the motion of the object, the smart home monitoring apparatus 100 photographs the monitoring area using the vision camera (Yes in step S1106). That is, the smart home monitoring apparatus 100 photographs the monitoring area using the vision camera to obtain an abnormal state occurrence prediction image such as fire occurrence.

In step S1108, the smart home monitoring apparatus 100 compares and analyzes the abnormal state occurrence prediction image of the monitoring area photographed by the vision camera and a previously stored image to determine whether the abnormal state such as fire occurrence.

In step S1109, when it is determined that the abnormal state such as fire occurrence as the image analysis result, the smart home monitoring apparatus 100 outputs an alarm (Yes in step S1108). In this case, for example, when the tire actually occurs, the smart home monitoring apparatus 100 may also provide the alarm to the fire station as well as the user. In the meantime, in step S1110, when the degree of the motion of the object exceeds the predetermined reference value, the smart home monitoring apparatus 100 analyzes the moving object (No in step S1106). For example, the smart home monitoring apparatus 100 may analyze what is the moving object based on information such as a temperature, a moving speed, a degree of motion, and a size of the moving object.

In step S1111, the smart home monitoring apparatus 100 determines whether a stranger trespasses as the moving object analysis result. That is, in a state in which the user is located at the outside of the monitoring area, when a human is detected in the monitoring area, the smart home monitoring apparatus 100 may determine that the stranger trespasses. In this case, in the present embodiment, it is determined whether the user is located in the monitoring area using a user recognizing unit such as a vision camera sensor and confirm whether the user is located at the outside of the monitoring area by the setting of the user. Further, in the present embodiment, when the moving object is analyzed as a stranger as a moving object analysis result or when an analysis result is not obvious, the moving object is photographed by the vision camera sensor to determine whether a stranger trespasses. That is, the smart home monitoring apparatus 100 analyzes the moving object image (or a video) obtained by the vision camera sensor to determine whether a stranger trespasses.

In step S1112, when the moving object is determined as a human as a moving object analysis result, the smart home monitoring apparatus 100 outputs an alarm indicating that there is stranger's trespassing through one or more of the output unit and the user terminal (Yes in step S1111). In this case, the smart home monitoring apparatus 100 may output an alarm including contents including a text, a stranger photographed image, and a monitoring area monitoring screen with respect to the stranger's trespassing.

In the meantime, when an object other than the human is analyzed as a moving object analysis result in step S1110, the smart home monitoring apparatus 100 returns step S1102 to receive the first inaudible sound wave echo signal (No in step S1111). That is, the smart home monitoring apparatus 100 may predict the possibility of abnormal state occurrence by reflecting moving object information in accordance with a moving object analysis result. That is, in the present embodiment, for example, when the moving object is analyzed as a robot cleaner or a pet, the monitoring area may be scanned again by the inaudible sound wave sensor by reflecting the analysis.

The example embodiments described above may be implemented through computer programs executable through various components on a computer, and such computer programs may be recorded in computer-readable media. Examples of the computer-readable media include, but are not limited to: magnetic media such as hard disks, floppy disks, and magnetic tape; optical media such as CD-ROM disks and DVD-ROM disks: magneto-optical media such as floptical disks; and hardware devices that are specially configured to store and execute program codes, such as ROM, RAM, and flash memory devices.

The computer programs may be those specially designed and constructed for the purposes of the present disclosure or they may be of the kind well known and available to those skilled in the computer software arts. Examples of program code include both machine code, such as produced by a compiler, and higher level code that may be executed by the computer using an interpreter.

As used in the present application (especially in the appended claims), the terms ‘a/an’ and ‘the’ include both singular and plural references, unless the context clearly states otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

Also, the order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example”, etc.) used herein are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various alterations, permutations, and modifications may be made within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. A smart home monitoring method, comprising:
generating a spatial map of a monitoring area;
transmitting a first inaudible sound wave signal to the monitoring area to receive a first inaudible sound wave echo signal;
predicting a possibility of abnormal state occurrence of the monitoring area through the first inaudible sound wave echo signal based on the spatial map of the monitoring area;
obtaining an image of the monitoring area photographed by the camera when the abnormal state occurrence of the monitoring area is predicted; and
determining whether the abnormal state occurs in the monitoring area by analyzing the obtained image.

2. The smart home monitoring method according to claim 1, wherein generating the spatial map of the monitoring area includes:
obtaining initial information of the first inaudible sound wave echo signal from the monitoring area by scanning the monitoring area through the first inaudible sound wave signal; and
obtaining distance information of a fixed object by recognizing a distance from the fixed object in the monitoring area through the camera.

3. The smart home monitoring method according to claim 1, wherein predicting the possibility of abnormal state occurrence includes:
obtaining a speed of the first inaudible sound wave in accordance with the first inaudible sound wave echo signal;
identifying a temperature for an arbitrary part in the monitoring area by a correlation between the speed of the first inaudible sound wave and a temperature; and determining whether the abnormal state occurs based on a temperature change in the arbitrary part in the monitoring area.

4. The smart home monitoring method according to claim 3, wherein predicting the possibility of abnormal state occurrence includes:
predicting a possibility of fire occurrence when the temperature for the arbitrary part in the monitoring area reaches a predetermined setting temperature or the temperature change for the arbitrary part in the monitoring area is equal to or higher than a predetermined reference value.

5. The smart home monitoring method according to claim 1, wherein determining whether the abnormal state occurs includes:
determining whether fire occurs by comparing an image photographed by the camera and a previously stored fire image.

6. The smart home monitoring method according to claim 1, further comprising:
transmitting a second inaudible sound wave signal to the monitoring area to receive a second inaudible sound wave echo signal; and
detecting whether there is a motion of an object in the monitoring area using the second inaudible sound wave echo signal based on the spatial map of the monitoring area.

7. The smart home monitoring method according to claim 6, wherein obtaining the image of the monitoring area includes:
photographing the monitoring area using the camera when a degree of motion of the object detected by the second inaudible sound wave echo signal is equal to or lower than a predetermined reference value.

8. The smart home monitoring method according to claim 6, further comprising:
analyzing a moving object when a degree of motion of the object detected by the second inaudible sound wave echo signal exceeds a predetermined reference value,
wherein predicting the possibility of abnormal state occurrence includes:
predicting the possibility of abnormal state occurrence by reflecting moving object information in accordance with the moving object analysis result.

9. The smart home monitoring method according to claim 8, further comprising:
outputting an alarm for stranger's trespassing when the moving object is determined as a human as the moving object analysis result if a user is located at the outside of the monitoring area.

10. The smart home monitoring method according to claim 1, further comprising:
outputting an alarm including one or more contents of a fire image, a cause of fire, and a fire extinguishing plan when the fire occurrence is determined.

11. A smart home monitoring apparatus, comprising:
a map generating unit for generating a spatial map of a monitoring area:
a first receiving unit for transmitting a first inaudible sound wave signal to the monitoring area to receive a first inaudible sound wave echo signal;
a predicting unit for predicting a possibility of abnormal state occurrence of the monitoring area through the first inaudible sound wave echo signal based on the spatial map of the monitoring area;
an image obtaining unit for obtaining an image of the monitoring area photographed by the camera when the abnormal state occurrence of the monitoring area is predicted; and
a controller for determining whether an abnormal state occurs in the monitoring area by analyzing the obtained image.

12. The smart home monitoring apparatus according to claim 11, wherein the map generating unit scans the monitoring area by the first inaudible sound wave signal to obtain initial information of the first inaudible sound wave echo signal from the monitoring area and recognizes a distance of a fixed object in the monitoring area through the camera to obtain the distance information of the fixed object.

13. The smart home monitoring apparatus according to claim 11, wherein the predicting unit obtains a speed of the first inaudible sound wave in accordance with the first inaudible sound wave echo signal, identifies a temperature for an arbitrary part in the monitoring area by a correlation between the speed of the first inaudible sound wave and a temperature, and determines whether an abnormal state occurs based on a temperature change for the arbitrary part in the monitoring area.

14. The smart home monitoring apparatus according to claim 13, wherein the predicting unit predicts a possibility of fire occurrence when the temperature for the arbitrary part in the monitoring area reaches a predetermined setting temperature or the temperature change for the arbitrary part in the monitoring area is equal to or higher than a predetermined reference value.

15. The smart home monitoring apparatus according to claim 11, wherein the controller determines whether fire occurs by comparing an image photographed by the camera and a previously stored fire image.

16. The smart home monitoring apparatus according to claim 11, further comprising:
a second receiving unit for transmitting a second inaudible sound wave signal to the monitoring area to receive a second inaudible sound wave echo signal; and
a motion detecting unit for detecting whether there is a motion of an object in the monitoring area using the second inaudible sound wave echo signal based on the spatial map of the monitoring area.

17. The smart home monitoring apparatus according to claim 16, wherein the image obtaining unit photographs the monitoring area using the camera when a degree of motion of the object detected by the second inaudible sound wave echo signal is equal to or lower than a predetermined reference value.

18. The smart home monitoring apparatus according to claim 16, wherein the motion detecting unit analyzes a moving object when a degree of motion of the object detected by the second inaudible sound wave echo signal exceeds a predetermined reference value and the predicting unit predicts the possibility of abnormal state occurrence by reflecting moving object information in accordance with the moving object analysis result.

19. The smart home monitoring apparatus according to claim 18, wherein the controller outputs an alarm for stranger's trespassing when the moving object is determined as a human as the moving object analysis result if a user is located at the outside of the monitoring area.

20. The smart home monitoring apparatus according to claim 11, wherein the controller outputs an alarm including one or more contents of a fire image, a cause of fire, and a fire extinguishing plan when the tire occurrence is determined.
